(19) United States
(12) Patent Application Publication
(10) Pub. No.: US 2024/0341541 A1
(43) Pub. Date: Oct. 17, 2024

(54) Portable Tailgate-Mounted Water System

(71) Applicant: Christopher Jackson Crawford, Carlsbad, CA (US)

(72) Inventor: Christopher Jackson Crawford, Carlsbad, CA (US)

(21) Appl. No.: 18/135,634

(22) Filed: Apr. 17, 2023

(51) Int. Cl. A47K 3/28; B60R 11/00

(52) U.S. Cl. CPC A47K 3/288; B60R 11/00; B60R 2011/004

(57) ABSTRACT

A portable water system is designed for mounting on the tailgate of a pickup truck. The system has a tailgate pad with a built-in water tank and pump. A hose is attached to the pump with a nozzle at the end of the hose opposite the pump. A pump pocket on tailgate pad next to the water tank holds the pump, allowing it to pump water from the water tank into the hose. In use, the system is mounted on a tailgate, the water tank is filled with water, and the pump is connected to the vehicle's electrical system. Once the truck and water system are in the location in which running water is desired, the pump is turned on, and water is dispensed through the hose by engaging the nozzle.

### FIELD OF THE INVENTION

The present invention pertains generally to portable water reservoirs. The present invention is particularly, but not exclusively, useful as a shower mountable on a vehicle tailgate for use in outdoor or remote environments.

### BACKGROUND OF THE INVENTION

Common recreational activities, such as camping, involve travel to locations in which running water—and often potable water in general—is unavailable. In response to the lack of potable water, participants in such activities sometimes bring water in containers, and sometimes bring filters and chemical treatment for locally sourced water, if sources (such as streams) are present. Nonetheless, transporting or treating water only provides a partial solution, as the conveniences of running water are still lacking.

In view of the above, it would be advantageous to provide a system for running water that can be used in remote locations.

### SUMMARY OF THE INVENTION

Disclosed is a portable water system designed for mounting on the tailgate of a pickup truck. The system has a tailgate pad with a built-in water tank and pump. A hose is attached to the pump with a nozzle at the end of the hose opposite the pump. A pump pocket on tailgate pad next to the water tank holds the pump, allowing it to pump water from the water tank into the hose. A seven-pin trailer connector allows the pump to be connected to the vehicle's electrical system in order to provide power to the pump on location. Thus the system provides pressurized, running water at any location that the vehicle with which it is used is taken.

The portable water system is used by mounting the tailgate pad on a tailgate, filling the water tank with water, and connecting the pump to the vehicle's electrical system. Once the truck and water system are in the location in which running water is desired, the pump is turned on, and water is dispensed through the hose by engaging the nozzle.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a preferred embodiment of a portable tailgate mounted water system;

FIG. 2 is a diagram of a preferred embodiment of a portable tailgate mounted water system illustrating the system mounted on the tailgate of a pickup truck; and

FIG. 3 is a diagram of a preferred embodiment of a portable tailgate mounted water system illustrating various components of the system.

### DETAILED DESCRIPTION

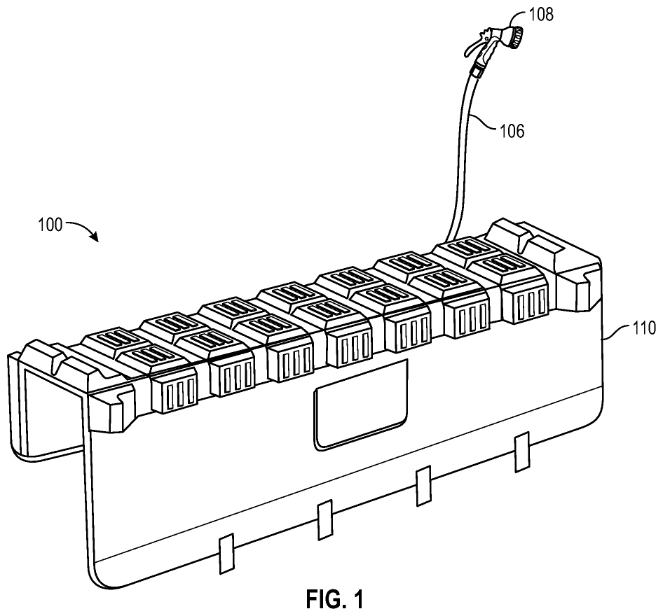

Referring initially to FIG. 1, a preferred embodiment of a portable tailgate mounted water system is illustrated and generally designated 100. System 100 has a hose 106 and nozzle 108 for dispensing water. Hose 106 and nozzle 108 are attached to a tailgate pad 110, which allows system 100 to be mounted on the back of a pickup truck. When mounted on a tailgate, portable tailgate mounted water system 100 provides a portable water supply and distribution system, useful as a shower and more generally as a source of pressurized water in a remote area or other situations in which pressurized water would otherwise be unavailable.

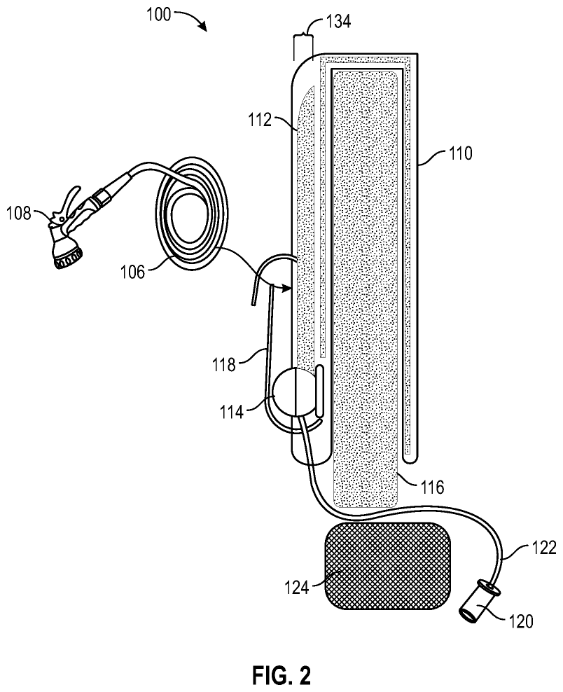

Referring now to FIG. 2, a diagram of components of a preferred embodiment of portable tailgate mounted water system 100 is shown. Water tank 112 and pump 114 provide water and water pressure, respectively, to system 100, and particularly to hose 106 and nozzle 108. In an exemplary configuration of a preferred embodiment, water tank 112 is located on the side of tailgate pad 110 that sits against the inside of a tailgate 116 of a pickup truck. Also on the same side of tailgate pad 110 is a pocket 118 where pump 114 is mounted on tailgate pad 110 and in which hose 106 and nozzle 108 are stored when not in use. When in use, hose 106 extends out from pocket 118, with the end opposite nozzle 108 remaining inside pocket 118 and connected to pump 114.

In a preferred embodiment, pump 114 is powered by an external power source, facilitated by a trailer connector 120 at the end of a cord 122 that runs between tailgate 116 and bumper 124 from trailer connector 120 to pump 114. A preferred embodiment of trailer connector 120 is a 7-pin connector, which facilitates providing power form pump 114 from the pickup truck's own electrical system.

In an alternate embodiment, pump 114 is powered by a power source built into system 100, such as a rechargeable battery. Some alternate embodiments include both a battery and a trailer connector 120, allowing pump 114 to be used with the vehicle's electrical system when the battery is drained, as well as allowing the battery to be charged via the vehicle's electrical system.

In an exemplary use scenario for system 100, tailgate pad 110 is mounted on a tailgate 116 of a pickup truck, and trailer connector 120 attached to the trailer wiring of the pickup truck. Pump 114 is then turned on, and water is dispensed, as desired, through hose 106 by engaging nozzle 108.

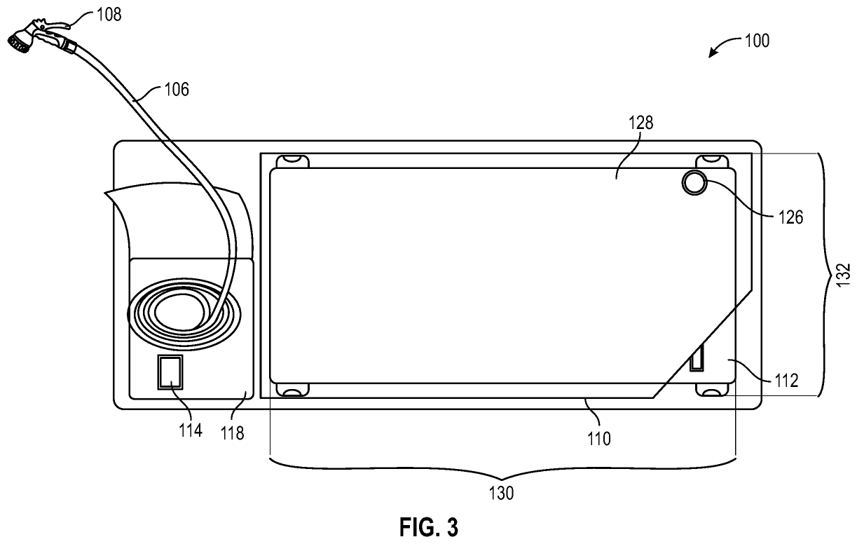

Referring now to FIG. 3, a rear view of portable tailgate mounted water system 100 illustrates a layout of features in a preferred embodiment. A preferred embodiment of water tank 112 is formed as a ribbed bag in order to maintain a degree of flexibility while generally retaining its shape and its ability to hold water. Water tank 112 is filled via a fill cap 126. In a preferred embodiment, water tank 112 and fill cap 126 are covered during use by tailgate pad 110 fabric 128.

Water tank 112 has a width 130, a height 132, and a thickness 134 (see FIG. 2) that determine the amount of water that water tank 112 is able to store. In a preferred embodiment, width 130 is fifty-three (53) inches, height 132 is thirty-three (33) inches, and thickness 134 is one (1) inch, allowing water tank 112 to hold approximately seven-and-a-half (7½) gallons of water.

While there have been shown what are presently considered to be preferred embodiments of the present invention, it will be apparent to those skilled in the art that various changes and modifications can be made herein without departing from the scope and spirit of the invention.

What I claim is:

1. A device that provides a portable, tailgate-mounted water system, consisting of:
a tailgate pad, wherein the tailgate pad has a water tank and a pump, wherein both the water tank and the pump are internal to the tailgate pad,
a hose with a nozzle at a terminal end of the hose, where the hose is attached to the pump, wherein the nozzle allows the dispensing of water in a variety of patterns,
a pump pocket, wherein the pump pocket facilitates pumping of water from the water tank to the hose,
an electrical connector from a vehicle, wherein the electrical connector connects the pump to a vehicle electrical system, wherein the vehicle electrical system powers the pump, thereby allowing the dispensing of water at whatever location the vehicle is parked.

2. The device of claim 1, wherein, the water tank has a height, a length, and a depth.

3. The device of claim 2, where the height is 33 inches, the length is 53 inches, and the depth is one inch.

4. The device of claim 3, where the water tank holds approximately 10 gallons of water.

5. The device of claim 4, wherein the electrical connector is a trailer connector.
